(19) United States
(12) Patent Application Publication
(10) Pub. No.: US 2014/0198335 A1
(43) Pub. Date: Jul. 17, 2014

(54) SECURING CONFIDENTIAL INFORMATION IN A DOCUMENT

(71) Applicant: HEWLETT-PACKARD DEVELOPMENT COMPANY, L.P., Houston, TX (US)

(72) Inventor: Ram Prasad Atmakur, Bangalore (IN)

(73) Assignee: Hewlett-Packard Development Company, L.P., Houston, TX (US)

(21) Appl. No.: 13/846,083

(22) Filed: Mar. 18, 2013

(30) Foreign Application Priority Data
Jan. 16, 2013 (IN) 221/CHE/2013

(51) Int. Cl. G06F 21/60; G06K 15/00

(52) U.S. Cl. CPC G06F 21/602; G06K 15/4095
USPC 358/1.14; 713/189

(57) ABSTRACT

Provided is a method of securing confidential information in a document. A user input is received to identify confidential information in a document. The confidential information is encrypted wherein encryption results in greeking of the confidential information. A password is associated with the encrypted confidential information, wherein the password is required to decrypt and ungreek the confidential information.

### CLAIM FOR PRIORITY

The present application claims priority under 35 U.S.C 119 (a)-(d) to Indian Patent application number 221/CHE/2013, filed on Jan. 16, 2013, which is incorporated by reference herein in its entirety.

### BACKGROUND

People share a variety of documents with each other. Many a times a document may contain private and confidential information which is meant for selective consumption only. Some examples of such documents may include bank statements, income tax returns, medical records, salary statements, birth records, etc. Indiscriminate or unintended disclosure of confidential information may harm or result in a loss to an interested party.

### BRIEF DESCRIPTION OF THE DRAWINGS

For a better understanding of the solution, embodiments will now be described, purely by way of example, with reference to the accompanying drawings, in which:

FIG. 1 shows a system for implementing a method of securing confidential information in a document, according to an example.

FIG. 2 illustrates a flow chart of a method of securing confidential information in a document, according to an example.

FIGS. 3A and 3B illustrate encryption of confidential information in a document to generate greeked confidential information, according to an example.

FIG. 4 illustrates a document containing encrypted confidential information and an encrypted password associated with the encrypted confidential information, according to an example.

FIG. 5 illustrates a method of ungreeking confidential information in a printed document containing greeked confidential information and an encrypted password associated with the greeked confidential information, according to an example.

### DETAILED DESCRIPTION OF THE INVENTION

As mentioned earlier, there could be a variety of documents which may contain private and confidential information. Unless necessary, people are usually wary of sharing such documents with others. However, there may be situations where such documents or at least some information present in such documents may need to be shared with other individuals.

For example, a potential employer may require a candidate to share a salary statement from his/her previous employment. Another example could include a bank requiring a loan applicant to provide an earlier tax return statement. In both aforementioned examples there could be some information or details in the document which an individual may be wary of disclosing even though he/she may be comfortable with sharing the rest of the contents. This could be due to a variety of reasons. One reason could be that each and every detail present in a document may not be needed by a receiving party. For instance, in the “loan” example mentioned earlier, a bank may only be interested in reviewing the salary income of an applicant and may not require information regarding his income from other sources or proceeds. The other reason could be that the information may be too private and confidential to be shared. To provide an example of this latter scenario, a bid manager may be okay with sharing of a bid document with his legal team for vetting but may not be comfortable with disclosure of any financial detail mentioned therein. Likewise, there could be many other reasons for an individual wanting to exercise control over sharing of private and/or confidential data in a document.

Proposed is a solution that provides a method of securing private and/or confidential information in a document. Proposed solution “secures” a document by selectively hiding private and/or confidential content in a document which an owner or user does not wish to share with another individual, although he/she may be alright with sharing the rest of the contents. Proposed solution also provides for printing of such documents.

For the sake of clarity, the term “document” in this document may include anything serving as a representation of a person's thinking by means of symbolic marks. In computer science terminology, it may include a computer file that contains text (and possibly formatting instructions) using seven-bit ASCII characters. The said term includes an electronic document as well. To provide some non-limiting examples, said term may include a text, an image, an illustration, a diagram, etc.

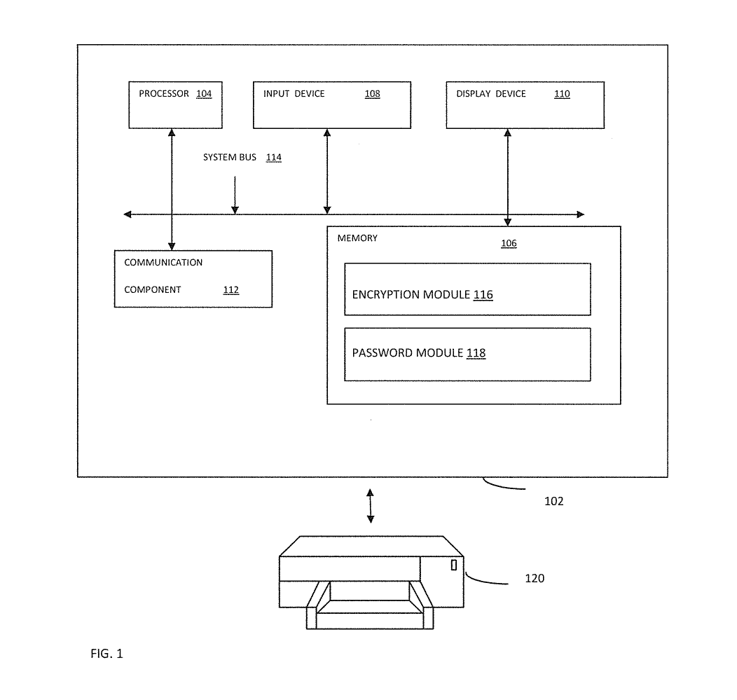

FIG. 1 shows a system 100 for securing confidential information in a document, according to an example. System 100 comprises computer system 102 and printer 120.

Computer system 102 may be a computer server, desktop computer, notebook computer, tablet computer, mobile phone, personal digital assistant (PDA), and the like.

Computer system 102 may include processor 104, memory 106, input device 108, display device 110, and a communication interface 112. The components of the computing system 102 may be coupled together through a system bus 114.

Processor 104 may include any type of processor, microprocessor, or processing logic that interprets and executes instructions.

Memory 106 may include a random access memory (RAM) or another type of dynamic storage device that may store information and instructions non-transitorily for execution by processor 104. For example, memory 106 can be SDRAM (Synchronous DRAM), DDR (Double Data Rate SDRAM), Rambus DRAM (RDRAM), Rambus RAM, etc. or storage memory media, such as, a floppy disk, a hard disk, a CD-ROM, a DVD, a pen drive, etc. Memory 106 may include instructions that when executed by processor 104 implements encryption module 116 and password module 118.

Encryption module 116 encrypts confidential information in a document as identified by a user. Encryption of the identified confidential information results in greeking of said confidential information. In an implementation, a password associated with encrypted confidential information in a document is encrypted by encryption module 116.

Password module 118 associates a password with encrypted confidential information in a document. Password module 118 may obtain and store a password provided by a user for association with encrypted confidential information. Password module 118 may also automatically generate a password for association with encrypted confidential information. Password module 118 may also manage password verification when a user provides a password to decrypt and ungreek encrypted confidential information.

Encryption module 116 and password module 118 may be implemented in the form of a computer program product including computer-executable instructions, such as program code, which may be run on any suitable computing environment in conjunction with a suitable operating system, such as Microsoft Windows, Linux or UNIX operating system. In an implementation, encryption module 116 and password module 118 may be read into memory 106 from another computer-readable medium, such as data storage device, or from another device via communication interface 112.

Input device 108 may include a keyboard, a mouse, a touch-screen, or other input device. Display device 110 may include a liquid crystal display (LCD), a light-emitting diode (LED) display, a plasma display panel, a television, a computer monitor, and the like.

Communication component 112 may include any transceiver-like mechanism that enables computing device 102 to communicate with other devices and/or systems via a communication link. Communication component 112 may be a software program, a hard ware, a firmware, or any combination thereof. Communication component 112 may provide communication through the use of either or both physical and wireless communication links. To provide a few non-limiting examples, communication component 112 may be an Ethernet card, a modem, an integrated services digital network (“ISDN”) card, etc.

Printer 120 is a peripheral device which produces a representation of an electronic document on physical media such as paper. Some non-limiting examples of printer 120 may include a dot-matrix printer, an inkjet printer, a laser printer, etc. Printer 120 may include a multifunction printer (MFP), also known as multi-function device (MFD), or all-in-one (AlO) printer. A MFP can print, scan, and copy among their many features. In an implementation, encryption module 116 and password module 118 may be hosted on printer 120.

It would be appreciated that the system components depicted in FIG. 1 are for the purpose of illustration only and the actual components may vary depending on the computing system and architecture deployed for implementation of the present solution. The various components described above may be hosted on a single computing system or multiple computer systems, including servers, connected together through suitable means.

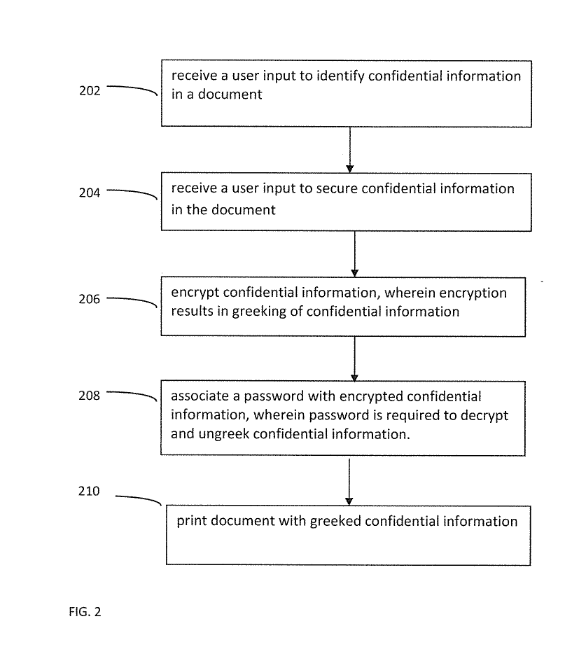

FIG. 2 illustrates a flow chart of a method of securing confidential information in a document. At block 202, a user input is received to identify confidential information in a document. To illustrate with an example scenario, let's assume that a user is working on a document on a computer system, such as of the type illustrated in FIG. 1. The said document could be a word processor document, a spreadsheet, an image, a figure, a drawing, or any other type of document for that matter. The said document could be a private and/or confidential document in its entirety or at least some portion of said document is private and/or confidential. In an implementation, if the entire contents of a document are private and/or confidential, then the document as such may be labeled “Private and/or Confidential”. Also, for the sake of clarity, content construed as private and/or confidential may depend on the owner, creator and/or user of a document. The classification of content as private and/or confidential may vary according to a user.

A user input to identify confidential information in a document may be received through an input device. Some non-limiting examples of an input device may include a keyboard, a mouse, a touch-screen, a microphone, etc. Using an input device, a user may identify confidential information in a document in a variety of ways. For example, a click-drag-release gesture though a mouse may be used to select (and thereby identify) confidential content in a document which a user may wish to secure. In another example, a keystroke or a combination of keystrokes on a key board may be sued to identify private and/or confidential data. In yet another example, a combination of a keystroke and a mouse gesture may be used by a user to mark confidential content in a document. In another example, a touch input on a touch screen of computer system may be used to provide an input for identifying confidential information in a document. Likewise, there are numerous other mechanisms through which a user can highlight content in a document which he/she wish to secure.

At block 204, once confidential information has been identified, a user input is received to indicate the user's intent to secure said confidential information. A user input to secure said confidential information may be received in a variety of ways. In an example, a user may provide said input by selecting a Graphical User Interface (GUI) element, such as but not limited to a menu, a window, an icon, a check box, a radio button, a tab, and the like. In an implementation, a “Secure content” option may be provided as part of a menu or a pull-down menu in the GUI of the application used for viewing or editing the document containing private and/or confidential information that a user wish to secure. In another implementation, a separate application or widget may be used to provide a user input that confidential information identified by a user needs to be secured. Likewise, there could be other mechanisms through which a user can provide an input to the computer system that confidential information identified by him/her in a document is required to be secured.

In an implementation, a user input to secure confidential information in a document may be received prior to identification of the confidential information. A user may identify beforehand that he/she wish to secure some information in a document which he/she considers to be private and/or confidential prior to identifying said information in a document. For example, a user may select the “Secure content” option explained above prior to identification of the information that needs to be secured. Likewise, other aforementioned options indicating user intent to secure private information may be exercised prior to the act of identification of said private information.

At block 206, confidential information identified in a document is encrypted. In other words, confidential information highlighted by a user for safeguarding is encoded in a way that an unauthorized party cannot read the confidential information. Encryption can be performed by an encryption algorithm or software (machine executable instructions). Many encryption algorithms are known in the art which could be used for encrypting contents of a document. In an implementation, encryption of confidential information identified by a user may be performed by an encryption module such as encryption module 116 of FIG. 1. Encryption module 116 encrypts confidential information in a document as identified by a user.

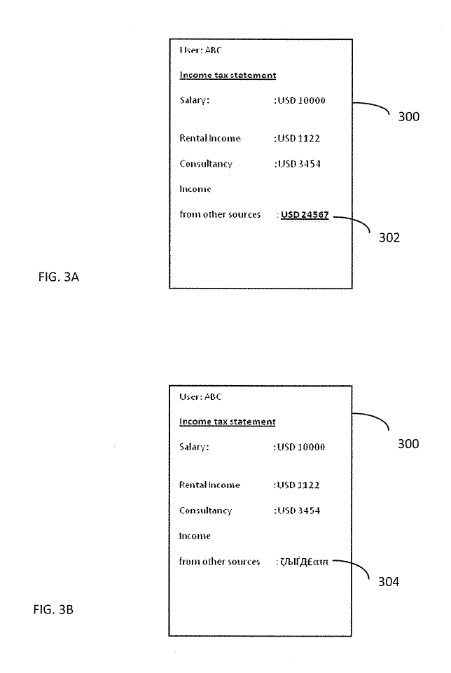

Encryption of the identified confidential information results in greeking of said confidential information. “Greeking” is rendering of text characters in a document as unreadable symbols or lines. It is a mechanism that includes use of unreadable characters to represent text or some other content in a document. It is also typically used to describe nonsensical text which is incomprehensible or unreadable to a user. FIGS. 3A and 3B illustrate encryption of confidential information in a document to generate greeked confidential information, according to an example. In the example, confidential information identified by a user (highlighted text 302) in a document 300 (FIG. 3A) is encrypted using an encryption algorithm to generate greeked confidential information. In the present case, document 300 is an income tax statement of a user (User: ABC) and the user has identified financial FIG. 302 corresponding to “Income from other sources” as confidential information. Upon user input to secure said information, the financial figure corresponding to “Income from other sources” is encrypted leading to greeking of said contents in the document 304 (FIG. 3B). The remaining contents of the document remain in their original state.

Greeking of identified confidential information results in a greeked document which could be printed (block 210). A printed greeked document includes original contents of the document except for the confidential information which is rendered in unreadable characters (“greeked” content).

At block 208, a password is associated with the encrypted confidential information. In an implementation, the password is provided by a user. In another implementation, the password may be automatically generated by an application and shared with a user. In either scenario, the password is required to decrypt and ungreek the confidential information. Said differently, once a password is coupled to an encrypted confidential information, said password is needed to decrypt the confidential information. Upon verification of the password, the confidential information is decrypted and ungreeked into original text. Once ungreeked, the actual text could be displayed for a user to view. In an implementation, association of a password with encrypted confidential information is performed by a password module such as password module 118 of FIG. 1. Password module 118 may also obtain and store a password provided by a user for association with encrypted confidential information. In another implementation, password module 118 may automatically generate a password for association with encrypted confidential information. Password module 118 may also be responsible for password verification when a user provides a password to decrypt and ungreek encrypted confidential information.

In an implementation, a password associated with encrypted confidential information in a document is also encrypted by an encryption algorithm. Encryption of said password may be carried out by encryption module 116. In an implementation, said encrypted password may be stored within the document that contains encrypted confidential information that said encrypted password is associated with. In an example, said encrypted password may be stored in the footer section of the document. In other examples, it may be stored at other locations in the document, such as the header section. In an implementation, said encrypted password may be stored in a barcode located on or appended to the document.

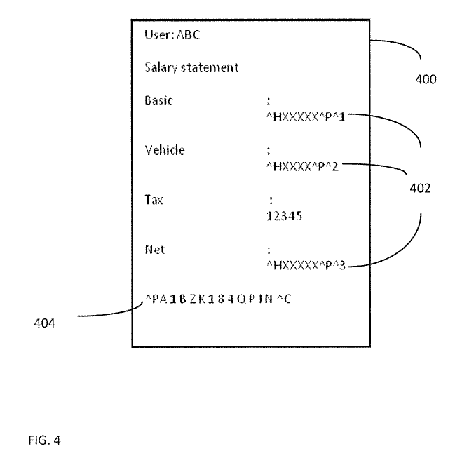

At block 210, a document containing encrypted confidential information and an associated encrypted password stored therein may be printed. An example illustration of such document is provided in FIG. 4, which shows a salary statement (document 400) containing encrypted confidential information 402 and encrypted password 404. Encrypted password 404, which is associated with encrypted confidential information 402, is placed (or stored) at the footer section of the salary statement 400.

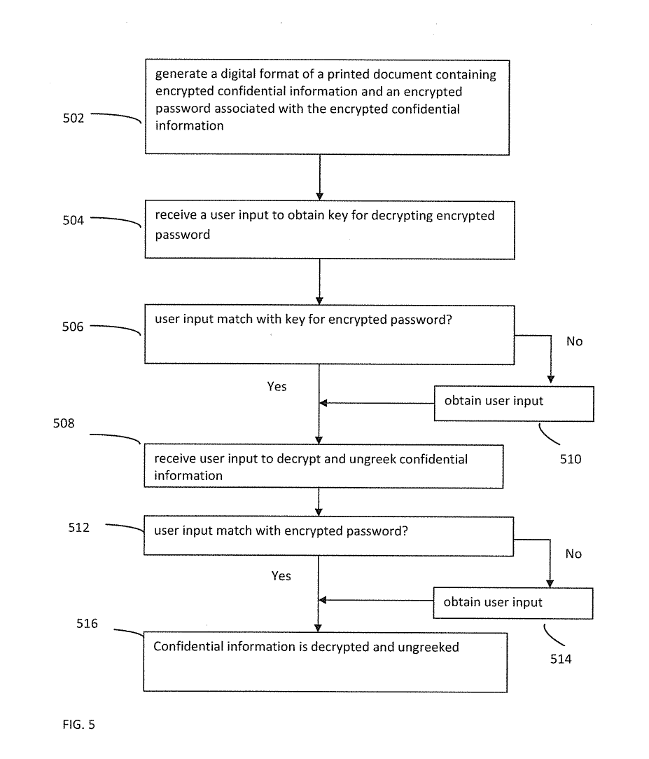

A user can share a printed document containing encrypted confidential information and an encrypted password associated with said encrypted confidential information, wherein said encrypted password is stored within the document, with other individuals. A receiving party can use the aforesaid printed document to decrypt and ungreek the confidential information in the document if the key for decrypting the password and the password itself is shared with the receiving party. In an implementation a receiving party can decrypt and ungreek the confidential information in a document in the following manner, which is illustrated in FIG. 5.

At block 502, a digital format of a printed document containing encrypted confidential information and an encrypted password associated with the encrypted confidential information is generated. In an example, a digital format of said printed document may be created by scanning said printed document. At block 504, a user is requested to provide a key for decrypting the password stored within the document. At block 506, a verification of the user input is made against the key for decrypting the password. If the verification is successful, the user is asked to provide a password to decrypt the greeked confidential information (block 508). If the verification fails, an error message may be displayed and the user is requested to provide the key again (block 510). At block 512, a verification of the user input is made against the password for decrypting the greeked confidential information. If a password provided by the user to decrypt the greeked confidential information is successful, the confidential information is decrypted and ungreeked (block 516). In other words, original text of the confidential information is generated and displayed to the user. On the other hand, if a password provided by the user to decrypt the greeked confidential information is unsuccessful, an error message may be displayed and the user is requested to provide the password again (block 514). Confidential information ungreeked in the aforesaid manner can be printed i.e. the digital format with ungreeked confidential information can be printed to obtain a physical version of the document. Proposed solution therefore allows regeneration of a secure softcopy of a document from an existing hardcopy. In case a softcopy of a document is deleted or unavailable at a particular instance, a secure softcopy of a document can be regenerated from the hardcopy.

It will be appreciated that the embodiments within the scope of the present solution may be implemented in the form of a computer program product including computer-executable instructions, such as program code, which may be run on any suitable computing environment in conjunction with a suitable operating system, such as Microsoft Windows, Linux or UNIX operating system etc. Embodiments within the scope of the present solution may also include program products comprising computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer.

For the sake of clarity, the term “module”, as used in this document, may mean to include a software component, a hardware component or a combination thereof. A module may include, by way of example, components, such as software components, processes, tasks, co-routines, functions, attributes, procedures, drivers, firmware, data, databases, data structures, Application Specific Integrated Circuits (ASIC) and other computing devices. The module may reside on a volatile or non-volatile storage medium and configured to interact with a processor of a computer system.

It should be noted that the above-described embodiment of the present solution is for the purpose of illustration only. Although the solution has been described in conjunction with a specific embodiment thereof, numerous modifications are possible without materially departing from the teachings and advantages of the subject matter described herein. Other substitutions, modifications and changes may be made without departing from the spirit of the present solution.

We claim:

1. A method of securing confidential information in a document, comprising:
receiving a user input to identify confidential information in the document;
encrypting the confidential information, wherein the encrypting results in greeking of the confidential information; and
associating a password with the encrypted confidential information, wherein the password is required to decrypt and ungreek the confidential information.

2. The method of claim 1, further comprising printing the document with greeked confidential information.

3. The method of claim 1, further comprising decrypting and ungreeking the confidential information in the document upon verification of the password.

4. The method of claim 1, further comprising encrypting the password and storing the encrypted password within the document.

5. The method of claim 4, further comprising printing the document with the encrypted password.

6. The method of claim 5, further comprising ungreeking the greeked confidential information in the printed document.

7. The method of claim 6, wherein ungreeking the greeked confidential information in the printed document comprises:
generating a digital format of the printed document;
receiving a key input to decrypt the encrypted password;
decrypting the encrypted password upon verification of the key input;
receiving a password to decrypt the greeked confidential information; and
ungreeking the confidential information upon verification of the password.

8. The method of claim 7, further comprising displaying ungreeked confidential information on a display.

9. The method of claim 7, further comprising printing the digital format of the printed document with ungreeked confidential information.

10. A system for securing confidential information in a document, comprising:
an input device to receive a user input to identify confidential information in the document;
an encryption module to encrypt the confidential information, wherein the encryption results in greeking of the confidential information; and
a password module to associate a password with the encrypted confidential is information, wherein the password is required to decrypt and ungreek the confidential information.

11. The method of claim 10, wherein the password is received from a user.

12. The method of claim 10, wherein the password is generated by an application.

13. The method of claim 10, wherein the confidential information includes one of a text, a figure and an image.

14. The method of claim 10, wherein the password is stored in a barcode present on the document.

15. A non-transitory processor readable medium, the non-transitory processor readable medium comprising machine executable instructions, the machine executable instructions when executed by a processor causes the processor to:
receive a user input to identify confidential information in a document;
encrypt the confidential information, wherein the encryption results in greeking of the confidential information; and
associate a password with the encrypted confidential information, wherein the password is required to decrypt and ungreek the confidential information.
